(19) United States
(12) Patent Application Publication
(10) Pub. No.: US 2023/0142844 A1
(43) Pub. Date: May 11, 2023

(54) USE OF 1,9-DECANEDIOL IN RETARDING UREA HYDROLYSIS

(71) Applicant: INSTITUTION OF SOIL SCIENCE, CHINESE ACADEMY OF SCIENCES, Nanjing (CN)

(72) Inventors: YUFANG LU, NANJING (CN); MINGKUN MA, DUNHUA (CN); WEIMING SHI, NANJING (CN)

(21) Appl. No.: 17/880,140

(22) Filed: Aug. 3, 2022

(30) Foreign Application Priority Data
Nov. 6, 2021 (CN) 2021113096727

(51) Int. Cl. C05G 3/40

(52) U.S. Cl. CPC C05G 3/40

(57) ABSTRACT

A use of 1,9-decanediol in retarding urea hydrolysis in soil is provided. It is found that 1,9-decanediol has a dual regulatory effect, which can not only inhibit the nitrification process, but also retard urea hydrolysis and reduce the transformation of urea to other nitrogen forms. As a fat-soluble root exudate, 1,9-decanediol has high stability in soil, is not easy to be leached away, and causes less environmental pollution. It further broadens an application field of 1,9-decanediol and improves an industrial value of 1,9-decanediol.

### TECHNICAL FIELD

The disclosure relates to the field of applications of nitrogen fertilizer synergist, and more particularly to a use/application of 1,9-decanediol in retarding urea hydrolysis.

### BACKGROUND

Utilization rate of nitrogen fertilizer in China is low to only 35%-39%, this is because a series of loss processes will occur when nitrogen fertilizer is applied to the soil. Urea is the main nitrogen fertilizer in China, accounting for more than 60% of nitrogen fertilizer consumption. When urea is applied to the soil, it will be rapidly transformed into ammonia nitrogen under an action of urease. Ammonia nitrogen will be transformed into nitrite nitrogen and nitrate nitrogen through nitrification. The nitrate nitrogen will produce nitrous oxide (N₂O), nitric oxide (NO), nitrogen (N₂) and so on, under an action of denitrification. The nitrate nitrogen is very easy to migrate in soil and pollute groundwater through runoff and leaching; and N₂O is a greenhouse gas, which will destroy the ozone layer when released into air. These ways cause loss of fertilizer nitrogen and reduce the utilization efficiency of plants. Therefore, retarding of urea release has an important practical significance for reducing nitrogen loss and improving nitrogen utilization rate.

In the prior art, urea coating and urease inhibitors are mostly used to retard urea hydrolysis, but coating materials are relatively expensive, and meanwhile, the coating materials are not easy to degrade, which are easy to cause pollution risk to the soil. At present, the urease inhibitors such as N-(N-butyl)thiophosphoric triamide (NBPT), hydroquinone (HQ), and p-phenylenediamine (PPD) used in the market, are mainly chemically synthesized, which have limitations of being not easy to decompose, unstable performance, being easy to cause groundwater pollution, and affecting the biodiversity of natural ecosystems. Therefore, development of green nitrogen fertilizer synergists derived from plants is a new strategy to reduce nitrogen loss in farmland and improve nitrogen utilization rate.

1,9-decanediol is a fat-soluble biological nitrification inhibitor found by the inventors in an early stage from root exudates of paddy rice, which can inhibit the nitrification process of nitrogen at a low concentration and reduce nitrogen loss (with reference to the Chinese Patent Application No. 201510926728.1, corresponding to Publication No. CN105439782A). However, the role of 1,9-decanediol in inhibiting urea hydrolysis has not been disclosed. In agricultural production, screening of plant-derived functional substances that simultaneously inhibit two nitrogen transformation processes of urea hydrolysis and nitrification will greatly promote research and development of new green and efficient nitrogen fertilizer products, which has important practical significance.

### SUMMARY

Technical problem to be solved: aiming at the above technical problem, the disclosure provides a use of 1,9-decanediol in retarding urea hydrolysis in soil. As urea is applied to soil, it will quickly decompose into ammonia nitrogen, which will be transformed into nitrate nitrogen. In this situation, it is difficult for crops to absorb nitrogen nutrition in time, resulting in loss of nitrogen. However, 1,9-decanediol can retard the hydrolysis of urea to ammonia nitrogen, reduce decomposition rate of urea, thereby increasing absorption of nitrogen by crops and reducing the loss of nitrogen.

Technical solutions: in an aspect, a use of 1,9-decanediol in retarding urea hydrolysis in soil is provided.

Specifically, 1,9-decanediol and urea are prepared into a mixed solution, and then the mixed solution is applied to soil.

In an embodiment, an addition amount of the 1,9-decanediol in the soil is in a range of 500 micrograms per kilogram (mg/kg) to1000 mg/kg.

In another aspect, a use of 1,9-decanediol in preparing a product for retarding urea hydrolysis in soil is provided.

In still another aspect, a use of 1,9-decanediol in retarding a transformation of urea to another nitrogen form in soil.

Beneficial effects: it is found that 1,9-decanediol has a dual regulatory effect, which can not only inhibit the nitrification process, but also retard urea hydrolysis and reduce the transformation of urea to other nitrogen forms, further expand the application field of 1,9-decanediol and improve the industrial value of 1,9-decanediol. With the increase of the addition of 1,9-decanediol, the effect of retarding the urea hydrolysis is more obvious. 1,9-decanediol, as a plant root exudate, is friendly to the environment. In addition, 1,9-decanediol, as a fat-soluble substance, has high stability in soil and is not easy to be leaked away.

### DETAILED DESCRIPTION OF EMBODIMENTS

Embodiment 1: 1,9-decanediol and urea are prepared into a mixed solution to be applied to soil, in which an addition amount of 1,9-decanediol in soil is 100 micrograms per kilogram (mg/kg).

Embodiment 2: 1,9-decanediol and urea are prepared into another mixed solution to be applied to soil, in which an addition amount of 1,9-decanediol in soil is 200 mg/kg.

Embodiment 3: 1,9-decanediol and urea are prepared into still another mixed solution to be applied to soil, in which an addition amount of 1,9-decanediol in soil is 500 mg/kg.

Embodiment 4: 1,9-decanediol and urea are prepared into even still another mixed solution to be applied to the soil, in which an addition amount of 1,9-decanediol in soil is 1000 mg/kg.

### TEST EXAMPLE

1. Experimental Design

1.1 experimental soil: the type of experimental soil is paddy soil, and the texture is sandy loam soil. It is collected from 0-20 cm topsoil of experimental field in Yingtan City, Jiangxi Province (28° 15′N, 116° 55′E). It is sieved by 2 millimeters (mm), mixed, and reserved. The basic physical and chemical properties are shown in Table 1.

1.2 test reagent: 1,9-decanediol is customized in market, and a structural formula thereof is C₁₀H₂₂O₂. Nitrification inhibitor is dicyandiamide (DCD, a structural formula thereof is C₂H₄N₄) is purchased from Sigma.

1.3 experimental treatment: experimental setting as follows: urea treatment (U); nitrification inhibitor DCD +urea treatment including: DCD-20 mg/kg soil; 1,9-decanediol+urea treatment in the soil including: 1,9-D-100 mg/kg, 1,9-D-200 mg/kg, 1,9-D-500 mg/kg, and 1,9-D-1000 mg/kg. Each treatment is repeated three times. The amount of nitrogen applied is 200 micrograms nitrogen per kilogram soil.

2. Experimental Procedures

After the experimental soil is weighed into 100 milliliters (mL) plastic pipe, distilled water is evenly added, and the soil water content is adjusted to 60% of the maximum field water capacity. Then the plastic pipe is sealed with sealing film and uniform holes are pricked to keep air flowing, and pre-cultured in a 25° C. incubator for three days.

After the pre-culture, according to the different experimental treatments, the corresponding urea and inhibitors (1,9-decanediol and DCD) are weighed to form a mixed solution, the mixed solution is evenly applied to soil, then distilled water is added to maintain a flooded state, and cultured at 25° C. in the field. The contents of urea nitrogen and ammonia nitrogen in soil are measured on the 1^{st}, 2^{nd}, 3^{rd}, 5^{th}, and 7^{th} days of culture to evaluate the effects of different inhibitors on nitrogen transformation.

3. Experimental Results

Application of 1,9-decanediol can retard the hydrolysis efficiency of urea, improve the retention time of urea in soil, reduce the conversion of urea to ammonia nitrogen, and retard the time when ammonia nitrogen reaches the peak (see Table 2). DCD has no effect on retarding the hydrolysis efficiency of urea. The efficiencies of retarding urea hydrolysis from large to small is 1, 9-D-1000>1, 9-D-500>1, 9-D-200>1, 9-D-100>DCD.

With the increase of the addition amount of 1,9-decanediol, the efficiency of retarding urea hydrolysis is more obvious. The addition of 1,9-decanediol 500 mg/kg and 1,9-decanediol 1000 mg/kg can significantly inhibit the urea hydrolysis during the culture period.

TABLE 1
Physical and chemical properties of soil

| | Total nitrogen | NH₄⁺—N | NO₃⁻—N | Organic matter |
|---|---|---|---|---|
| pH | (g/kg) | (mg/kg) | (mg/kg) | (g/kg) |
| 5.06 | 0.92 | 9.94 | 7.49 | 16.6 |

TABLE 2
contents of ammonia nitrogen and urea nitrogen in soil

| | Nitrogen | | | | | |
|---|---|---|---|---|---|---|
| Treatment | forms | 1 d | 2 d | 3 d | 5 d | 7 d |
| U | NH₄⁺-N | 157.6 ± 1.7b | 208.6 ± 3.6a | 205.8 ± 3.4a | 216.3 ± 4.5a | 228.7 ± 5.9a |
| | Urea-N | 7.9 ± 0.9c | 4.9 ± 0.2c | 3.5 ± 0.7d | 3 ± 0.2c | 2.3 ± 0c |
| DCD | NH₄⁺-N | 176.9 ± 5.5a | 183.6 ± 4b | 203.1 ± 1.6ab | 208.4 ± 1.6b | 217.9 ± 4.3b |
| | Urea-N | 4.5 ± 0.4c | 1.6 ± 0.3d | 1.4 ± 0.2e | 1.2 ± 0.1d | 2.9 ± 0.4bc |
| 1,9-D-100 | NH₄⁺-N | 171.9 ± 8.1a | 176.8 ± 1.2c | 197.7 ± 7.3ab | 187.3 ± 8.5d | 221.7 ± 2.4ab |
| | Urea-N | 10.1 ± 0.7c | 3.7 ± 1.2cd | 3.4 ± 0.5d | 3.3 ± 0.2c | 2.9 ± 0.5bc |
| 1,9-D-200 | NH₄⁺-N | 150.8 ± 2.8b | 173.7 ± 1.9c | 195 ± 9b | 213.9 ± 3.3ab | 221.4 ± 4.4ab |
| | Urea-N | 15.2 ± 0.1c | 9.1 ± 0.51b | 5.5. ± 1.0c | 2.8 ± 0.5c | 4.2 ± 1.4ab |
| 1,9-D-500 | NH₄⁺-N | 51 ± 1.1c | 160.2 ± 6.2d | 180.8 ± 6.3c | 207.3 ± 2.1b | 217.3 ± 3.3b |
| | Urea-N | 115.6 ± 13b | 11.7 ± 0.4b | 10.5 ± 0.7b | 6.1 ± 0.6a | 3.4 ± 0.7bc |
| 1,9-D-1000 | NH₄⁺-N | 46.3 ± 2.1c | 92.9 ± 0.4e | 152 ± 1.4d | 196.7 ± 2c | 203.2 ± 7c |
| | Urea-N | 139 ± 7.2a | 73.4 ± 3.8a | 14.8 ± 1.7a | 5 ± 0.5b | 5.4 ± 0.5a |

1. A use of 1,9-decanediol, comprising:
preparing a mixed solution based on the 1,9-decanediol and urea; and
applying the mixed solution to soil containing urease, and the 1,9-decanediol of the mixed solution acting as an inhibitor of the urease to reduce a conversion of the urea to an ammonia nitrogen and thereby retard in retarding urea hydrolysis in the soil.

2. (canceled)

3. The use according to claim 1, wherein an addition amount of the 1,9-decanediol in the soil is in a range of 500 micrograms per kilogram (mg/kg) to 1000 mg/kg.

4-6. (canceled)
